(19) United States
(12) Patent Application Publication
(10) Pub. No.: US 2018/0153769 A1
(43) Pub. Date: Jun. 7, 2018

(54) CHILD RESISTANT BLISTER CARD PACKAGE

(71) Applicant: Dr. Reddy's Laboratories Ltd., Hyderabad (IN)

(72) Inventors: Barun Kumar Dey, Dist- Birbhum (IN); Dolanchampa Bhattacharjee, Kolkata (IN); Shritej Vishnupant Kakade, Pune (IN); Janardan Narayan Kshirsagar, Pune (IN); Tathagata Kundu, Hyderabad (IN)

(21) Appl. No.: 15/824,458

(22) Filed: Nov. 28, 2017

(30) Foreign Application Priority Data
Dec. 1, 2016 (IN) 201641041126

(51) Int. Cl. A61J 1/03; B65D 75/36; B65D 75/52

(52) U.S. Cl. CPC A61J 1/035; B65D 75/527; B65D 75/367

(57) ABSTRACT

The invention relates to novel child-resistant blister card packages for medicaments. The blister card package comprises a rigid container sheet with cavities for containing a medicament and a cover sheet sealed to the container sheet and covering the cavities. The blister card package is detachable into individual sections or units, along lines of perforations. Each individual blister packing unit comprises a tear tab, a fold tab and at least one crease tab. The user operates three-step opening process, namely, tear-fold-tear, to open and access the medicament from the individual blister unit.

### PRIORITY DOCUMENT

This patent application claims priority to Indian Provisional Patent Application number 201641041126 filed on Dec. 1, 2016, the contents of which are incorporated by reference herein.

### FIELD OF THE INVENTION

The present invention relates to a child-resistant blister card package and particularly to an opening feature for a blister-type package.

### BACKGROUND OF THE INVENTION

Blister card packages are commonly used to package pharmaceutical dosage forms to the consumer. They are substantially tamperproof, airtight, lightweight and economical to produce. Blister card packages also have a rigidity that protects the packaged item from damage during shipping and handling.

In conventional blister card packages individual dosages are separately stored, which effectively meters the correct dosage to a patient. For example, each dosage in a blister card package can be separated by perforations such that it can be readily detached. Blister card packages normally are constructed of several layers. Typically, the container sheet or top sheet, which is usually transparent, contains integrally-formed blisters or cavities designed to hold the blister contents. The container sheet is sealed to a cover or closure sheet, which normally consists of a foil and paper laminate. In some blister card packages the pill is accessed by pressing it through the closure sheet, where the closure sheet is made of a rupturable material. In other cards, the closure sheet is peeled off from the top sheet to release the blister contents. In other cards, the cards are to be torn with some effort to access the medicaments.

A problem with many blister card packages is that they can be difficult to open. In a rupturable package, for example, the pill may crumble during opening. In a peel-apart package, the layers can be very difficult to separate because they are thin and are sealed tightly together. Moreover, blister card packages have become very popular for the child-resistant packaging of medicaments. It is desirable to provide a child resistant blister card package that is difficult for children, yet not unduly difficult for adults to open. There is always a need for a child resistant blister card package which can be economically produced, which provide the packaging and shipping advantages of blister card packaging yet allows easy opening for adults.

### SUMMARY OF THE INVENTION

The present specification relates to novel child-resistant blister card packages for medicaments.

The blister card package of the present invention comprises a rigid container sheet with cavities for containing a medicament product such as a pill and a cover (or closure) sheet sealed to the container sheet and covering the cavities. The blister card package is detachable into individual sections or units, along lines of perforations, with each unit containing at least one covered cavity around which the container sheet is sealed to the closure sheet.

Each individual blister packing unit comprises a tear tab, a fold tab and at least one crease tab. In order to access the medicament from the individual single unit, the user operates on the principle of three-step opening process, namely, tear-fold-tear, to access the medicament from the cavity. The user first tears blister unit starting from the tear tab edge and going through the tear line to the tear tab end. This allows opening of a detachable section of the blister unit which is then folded along with fold tab line and pulled apart from the unit. The user then tears the unit from a notching edge in the direction of the crease tab and towards the cavity. This allows the user to access the medicament in the cavity. This three-step opening pattern along with the configuration facilitates child resistance of the blister unit.

These and other features, objects, and advantages of the present invention will become apparent upon reading the following description thereof together with reference to the accompanying drawings.

### BRIEF DESCRIPTION OF THE DRAWINGS

FIG. 1 illustrates a top view of one embodiment of the blister card package. The blister package comprises a sheet having separable units divided by perforations extending along a horizontal axis X and a vertical axis Y, wherein one of the separable units has been separated from the sheet and each separable unit has a cavity for storage of a medicament.

FIG. 2 illustrates a side cross sectional view of a blister card package sheet having separable units along cross section as shown in FIG. 1.

FIG. 3 illustrates a top view of a covering for a blister card package sheet having separable units as shown in FIG. 1, wherein one of the separable units has been separated from the sheet;

FIG. 4a illustrates a top view of an individual unit separated from the blister card package sheet as shown in FIG. 1 and comprises a tear tab, fold tab and at least one crease tab.

FIG. 4b illustrates a top view of an individual unit separated from the blister card package sheet as shown in FIG. 1 and comprises a tear tab edge and notching edge with space apart configuration.

FIG. 5 illustrates a top view of an individual unit separated from the blister card package with opening steps instruction to access the medicament from the cavity.

FIG. 6a illustrates a top view of an individual unit separated from the blister card package with sequential opening steps to access the medicament from the cavity as per the instruction given in FIG. 5.

FIG. 6b illustrates a top view of an individual unit separated from the blister card package with sequential opening steps to access the medicament from the cavity as per the instruction given in FIG. 5.

FIG. 6c illustrates a top view of an individual unit separated from the blister card package with sequential opening steps to access the medicament from the cavity as per the instruction given in FIG. 5.

FIG. 7 illustrates a top view of different embodiments of an individual unit separated from the blister card package.

FIG. 8 illustrates a top view of different embodiments of an individual unit separated from the blister card package.

### DESCRIPTION OF THE INVENTION

The present specification relates to novel child-resistant blister card packages for medicaments.

Child-resistant (C-R) packaging, also referred to as “special packaging,” is used to reduce the risk of poisoning in children via the ingestion of potentially hazardous items including certain prescription and over-the-counter (OTC) medications, pesticides, and household chemicals. The term “special packaging” means packaging that is designed or constructed to be significantly difficult for children under five years of age to open or obtain a toxic or harmful amount of the substance contained therein within a reasonable time and not difficult for normal adults to use properly, but does not mean packaging which all such children cannot open or obtain a toxic or harmful amount within a reasonable time.

As used herein, the term “blister pack” or “blister card package” is to be understood to refer to a package of medicament (or similar product), in which discrete quantities or units of the medicament are stored in a blister and dispensed by applying force (e.g., a tearing force or a pushing force) to the blister to expel or dispense the medicament from the blister pack. The present application can be utilized with currently available blister packaging technology, adapted for use with known blister pack configurations, or adapted for use with blister packs specifically designed to be incorporated into the present configuration.

As used herein, the term “medicament” is to be understood to refer to a variety of medications, including prescription and non-prescription medications, nutrients, dietary supplements, vitamins, etc. These can be in solid, liquid and/or semi-solid dosage forms (e.g., gels) and can be in the form of tablets, mini-tablets, capsules, powders, liquids, creams, granules, etc.

Referring to the drawings, FIG. 1 shows one embodiment of a blister card package in accordance with the present invention. The blister card package 10 is separated into ten individual dosage sections or units 21. Each individual section 21 is provided with a raised cavity 22 in the container sheet or top sheet 12 to accommodate a pill, medicament or the like stored therein. Each individual discrete section is detachable from the blister card package due to perforations running transversely in two directions (X, Y) and intersecting between the individual sections. Each individual section 21 may be detached from the blister card package 10 by bending and tearing along the lines of perforations, as is known in the art.

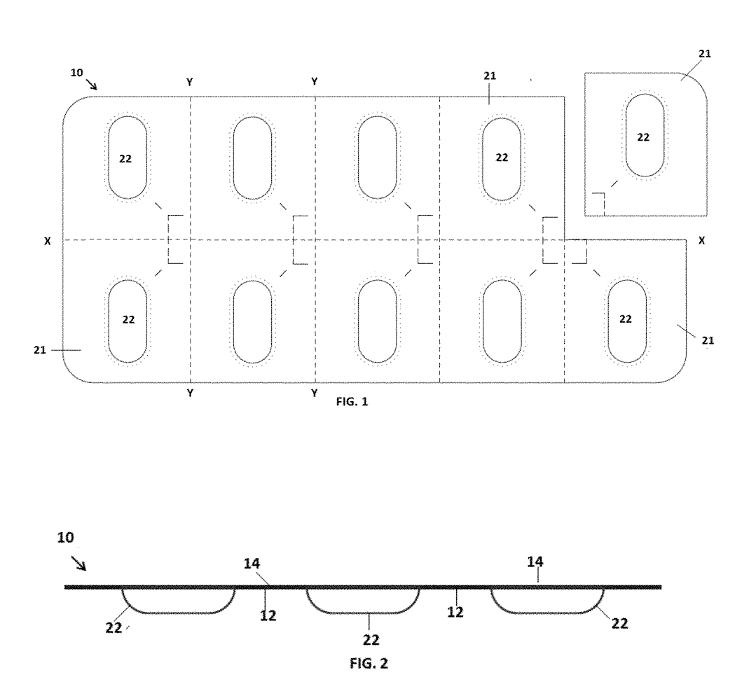

The blister card package 10 comprises a container sheet 12 and a cover sheet 14 as shown in FIG. 2.

The container sheet 12 is preferably formed of a strong, rigid and polymeric material, such as polyvinylchloride (PVC), cyclo-olefin-copolymer (COC), polychlorotrifluoroethylene (PCFE), polyethylene (PE), polypropylene (PP), polyethylene terephthalate (PET), polycarbonate (PC), polyester (UP), polyacrylate, polyamide (PA) or another plastic or a multi-layer composite plastic film. The container sheet could be transparent. The container sheet has a substantial thickness to provide a sufficiently rigid structure to prevent the product encased in the cavity from being crushed during shipping and also prevents child access to the product by biting or tearing through the container sheet. The cavities 22 are integrally formed in the container sheet, and may be of any desired size or configuration, depending on the dosage form to be stored.

The cover sheet 14 (or closure sheet) is preferably a laminate of thin metal foil, e.g. aluminum foil and a paper layer with the foil side of the laminate exposed to the medicament stored in the cavity and the paper side comprising the outer (bottom) layer of the assembled blister card package. A paper layer is optional and may allow print to be placed on the blister pack and may serve as a label. Preferably, the label is provided on the back of the blister card such that a complete label is provided on the back (i.e. on the paper layer) of each section. The label may include the name of the medicament, the lot number, the expiration date, directions for opening the blister card package sections, or other identifying information.

In some embodiments, laminate form of the cover sheets could be used for either one or multiple layers for covering. The multi-layered laminate forming the closure sheet may have two or more layers including the adhesive bond layer between the different components. This increases the structural integrity of the blister card package which also facilitates child resistance.

The container sheet 12 and closure sheet 14 are sealed together substantially entirely from the outer edges of the card to the edges of the cavities. The sealing between layers is accomplished by conventional means such as heat sealing or adhesives.

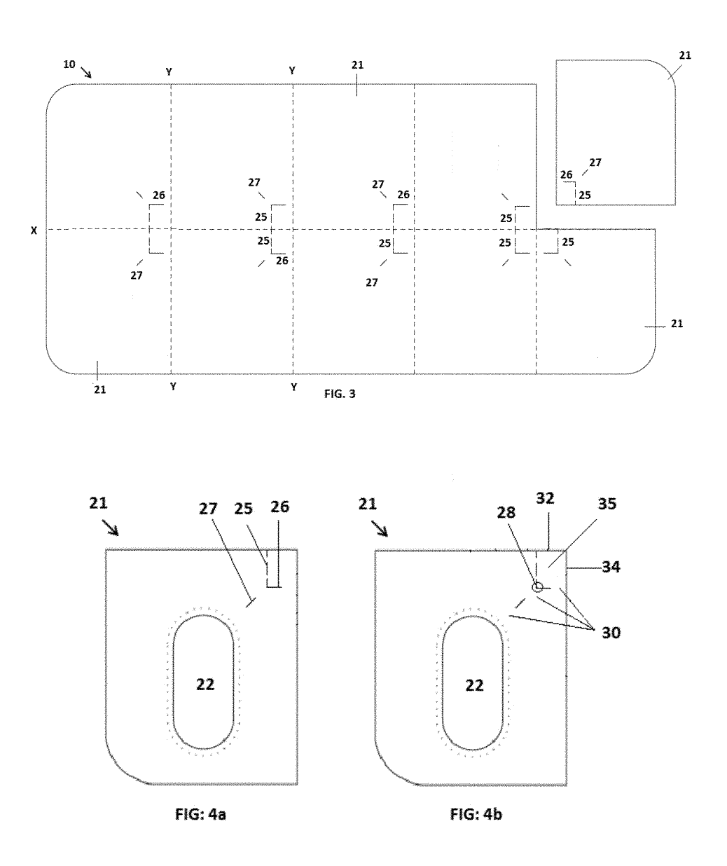

Each individual blister packing unit 21 comprises a tear tab 25, fold tab 26 and at least one crease tab 27 (FIG. 3 and FIG. 4a)

The tear tab 25 is a die cut, which is typically created through set of perforation from one edge of blister unit to a certain point in the said unit. The tear tab forms a tear line. The tear tab facilitates to tear the blister unit from one particular edge 32 (or tear tab edge 32) along with the tear line. The tear tab is the only area which allows the user to tear the individual blister unit.

The fold tab 26 is a die cut, which is created through set of perforation or fold line from the other edge 34 (or fold tab edge 34) which is adjacent to the tear tab edge. The fold tab is created with a space apart 30 from the fold tab edge. The term “space apart” is defined as the space or gap in the blister packaging unit or card without having any die cut or perforation. The length of the space or gap in “space apart” configuration between the fold tab and the fold tab edge could vary as required, for e.g. 1 mm, 1.5 mm, 2 mm, 3 mm, 4 mm, 5 mm. The fold tab meets with the tear tab end and thereby creating a notching edge 28 at the meeting point. Typically, the angle between the tear tab and the fold tab at notching edge is less than 180°, e.g. 30°, 60°, 90°, 120°. The fold tab facilitates to fold the blister unit along with the fold line.

The crease tab 27 is a die cut and it is located between the cavity and notching edge 28 with a space apart 30 from both the cavity and notching edge 28. Such space apart configuration in the blister requires higher force to tear the blister unit and thereby facilitates tamper resistance and child resistance. In some embodiments, there may be more than one crease tab with a space apart in between to increase the child resistance. The length of the “space apart” configuration between the cavity and crease tab or between the crease tab and notching edge could vary as required for e.g. 1 mm, 1.5 mm, 2 mm, 3 mm, 4 mm, 5 mm.

In order to access the medicament from the blister card package, an individual single unit 21 is detached from the blister card package 10 by bending and tearing along the perforation. When a single unit 21 is detached from the card, the user first tears blister unit starting from the tear tab edge 32 and going through the tear line 25 to the tear tab end. This allows opening of a small detachable section 35 of the blister unit which is then folded along with fold tab 26 line and pulled apart or torn from the unit. The user then tears the unit from notching edge 28 in the direction of the crease tab 27 and towards the cavity 22. This allows the user to access the medicament in the cavity.

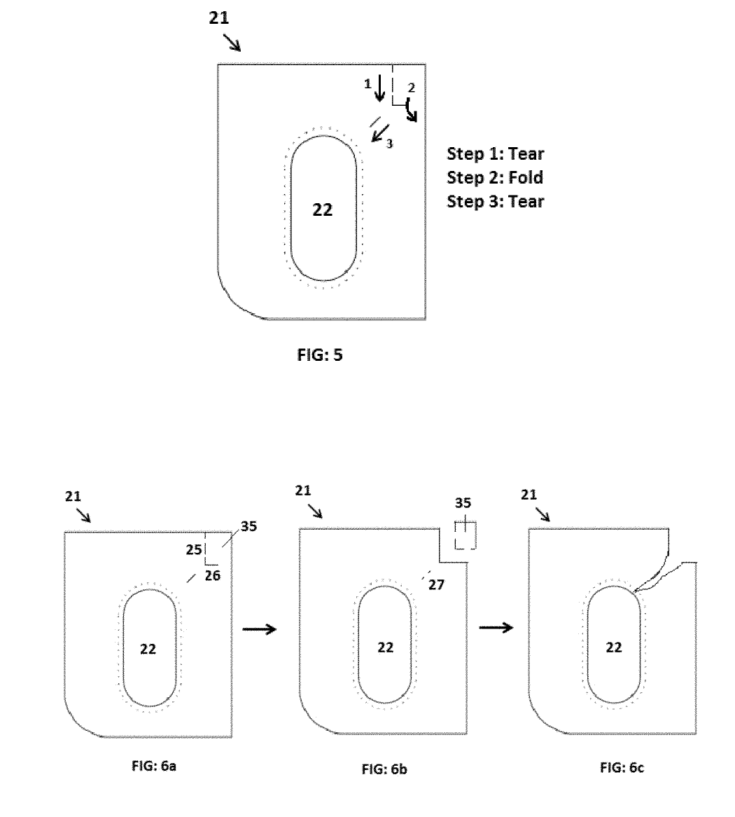

Thus the system of the present invention operates on the principle of three-step (FIG. 5, FIG. 6a, FIG. 6b and FIG. 6c) opening process namely tear-fold-tear to access the medicament from the cavity. This three-step opening pattern along with the space apart configuration facilitates child resistance of the blister unit.

The die cut or perforation or creases can be applied to the container sheet and/or covering sheet (or closure) by for example, rotary pinned or needles using cold or heated pins or needle punches or die punch sets or by laser etching or cutting to place the perforations which are well known in the art.

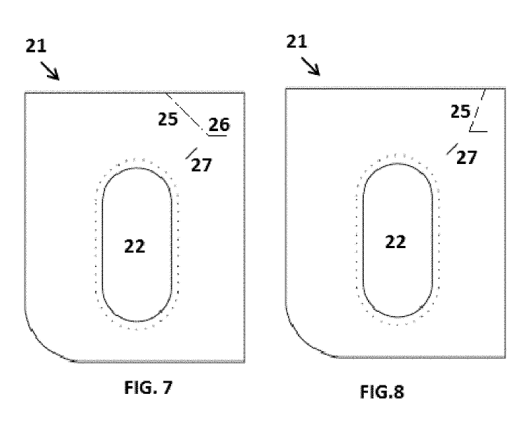

In other embodiments of the present specification, as shown in FIG. 7 and FIG. 8, wherein the angle between the tear tab and fold tab is greater than 90° and less than 90° respectively.

The above preferred aspects are not limiting and the card can be varied in ways apparent to the skilled artisan reading the foregoing disclosure. For example, the size and shape of the card, the cavities that hold the product, sections of the card, position of the tabs, and sealed and unsealed zones are subject to variation. Not every one of the detachable sections need contain a product cavity. The various layers may be modified or added to without departing from the invention as described.

### Child Resistant Test

The blister card packages of the present invention were subjected to child resistant test as per the protocol and final rule set forth by the Consumer Product Safety Commission (CPSC) dated Jul. 21, 1995 and 16 CFR parts 1700.15 and 1700.20. The test consisted of two-hundred (200) children of 42-51 months and being tested in 50 sites. Each child was given one blister card with 9 tablets in each card for testing and the instructions on the unit dose explaining how to open the package. The number of children able to open the blister card was recorded (Table 1). The opening was defined by any access to the tablets. The CPSC requires a child-resistant effectiveness of no less than 80% percent with 200 children tested. The child-resistant effectiveness for the blister card packages according to the present invention were 81.50% percent with 200 children tested. The blister card packages were found to be child-resistant.

TABLE 1
Child resistant test results

| Observation | Number of children able to open |
|---|---|
| Children accessing 0 Unit | 163 |
| Children accessing at least 1 Unit | 37 |
| Children accessing at least 2 Units | 7 |
| Children accessing at least 3 Units | 3 |
| Children accessing at least 4 Units | 3 |
| Children accessing at least 5 Units | 1 |
| Children accessing at least 6 Units | 0 |
| Children accessing at least 7 Units | 0 |
| Children accessing at least 8 Units | 0 |
| Children accessing 9 or above Units | 0 |

1. A child-resistant blister card packaging unit 21 having a container sheet 12 with at least one cavity 22 configured to kept at least one dose of medicament and a cover sheet 14, wherein the said blister packaging unit comprises:
i. a tear tab 25, created through set of perforations from one edge of blister unit,
ii. a fold tab 26, created through set of perforations from the other adjacent fold tab edge with a space apart 30 from that edge and the said fold tab meets with the tear tab end and thereby creating a notching edge 28 at the meeting point, and
iii. at least one crease tab 27 created through set of perforations, wherein the crease tab is located between the cavity 22 and the notching edge 28 with a space apart 30 from both the cavity and notching edge.

2. The child-resistant blister card packaging unit according to claim 1, wherein the length of the space apart between the fold tab and the fold tab edge is less than 5 mm.

3. The child-resistant blister card packaging unit according to claim 1, wherein the length of the space apart between the fold tab and the fold tab edge is less than 3 mm.

4. The child-resistant blister card packaging unit according to claim 1, wherein the length of the space apart between the cavity and the crease tab is less than 5 mm.

5. The child-resistant blister card packaging unit according to claim 1, wherein the length of the space apart between the crease tab and the notching edge is less than 5 mm.

6. The child-resistant blister card packaging unit according to claim 1, wherein the angle between the tear tab and the fold tab at notching edge is less than 180°.

7. The child-resistant blister card packaging unit according to claim 1, wherein the angle between the tear tab and the fold tab at notching edge is 90°.

8. The child-resistant blister card packaging unit according to claim 1, wherein the angle between the tear tab and the fold tab at notching edge is 120°.

9. The child-resistant blister card packaging unit according to claim 1, wherein the angle between the tear tab and the fold tab at notching edge is 60°.

10. A method of opening the child-resistant blister card packaging unit according to claim 1, said method comprising the steps of:
i. tearing the blister unit from the tear tab edge through the tear line 25 to the tear tab end,
ii. folding the small detachable section 35 of the blister unit along with fold tab line 26, and pulled apart from the blister unit, and
iii. tearing the blister unit from the notching edge 28 towards the cavity 22 through the crease tab 27 to access the medicament kept in the cavity.
